(19) United States
(12) Patent Application Publication
(10) Pub. No.: US 2004/0024793 A1
(43) Pub. Date: Feb. 5, 2004

(54) Data processing method, and memory area search system and program

(75) Inventor: Kiyokuni Kawachiya, Yokohama-shi (JP)

Correspondence Address: IBM CORPORATION, INTELLECTUAL PROPERTY LAW DEPT., P. O. BOX 218, YORKTOWN HEIGHTS, NY, 10598, US

(73) Assignee: International Business Machines Corporation, Armonk, NY

(21) Appl. No.: 10/376,090

(22) Filed: Feb. 27, 2003

(30) Foreign Application Priority Data
Feb. 28, 2002 (JP) 2002-054611

(51) Int. Cl. G06F 12/00

(52) U.S. Cl. 707/201

(57) ABSTRACT

To provide a technique for implementing a practical memory area search cache. A data processing method which carries out memory area searches in a multi-thread environment when a program is run by a computer includes the steps of: reading an entry corresponding to a given search address from a cache table stored in memory; reading, from memory, a memory area structure pointed to by a pointer registered in the entry; and handling the memory area structure as a search result if the entry in the cache table has not been overwritten and if the search address lies between the start and end addresses stored in the memory area structure.

### FIELD OF THE INVENTION

The present invention relates to efficient judgment of what memory area a given address belongs to, in computer data processing.

### BACKGROUND ART

Run-time modules of Java® JIT compilers judge frequently to what memory area (specifically, JIT-compiled code) a given address in memory belongs. To make this judgment, it is necessary to use binary search, which involves fairly heavy processing (high processing costs). However, since the same addresses very often occur in the same memory areas when searching for addresses in making this judgment, it is possible to speed up processing by storing recent judgment results in cache (memory area search cache) and carrying out searches with reference to the cached judgment results.

Conventional techniques for storing such judgment results involve atomically (inseparably) reading and writing each entry of the information stored in a memory area search cache, wherein the entry is composed of two words:

{search address, pointer to corresponding memory area structure}

FIG. 9 is a diagram showing a data structure of a conventional memory area search cache. Referring to FIG. 9, an entry of a cache table (hereinafter referred to as a cache entry) consists of a search address (pc1) and a pointer (cc1) to a corresponding memory area structure. Then, the two words of information is read and written atomically.

Two words are read and written atomically to avoid a situation in which after a given thread reads the “search address” in the cache entry, the content of the “pointer to the corresponding memory area structure” would be overwritten by another thread before the given thread reads the pointer, in a multi-thread environment. Thus, by handling two words in a set, the conventional techniques ensure consistency of registration and search among multiple threads.

However, IA-64 processors do not have the capability to read and write two words or 128 bits of data atomically. Therefore, if each cache entry in the memory area search cache is composed of two words—“search address” and “pointer to the corresponding memory area structure,” each of the two words must be read separately. Consequently, in a multi-thread environment, after the “search address” is read, the content of the “pointer to the corresponding memory area structure” may be overwritten by another thread before it is read. Thus, the conventional techniques cannot implement a memory area search cache.

In such a case, it is conceivable to lock the cache for exclusive control when the “search address” is read by a given thread, and thereby prevent other threads from accessing the cache.

However, the process of locking the cache involves high processing costs and is not suitable for a frequently repeated process of judging what memory area a given address belongs to.

### SUMMARY OF THE INVENTION

Thus, an aspect of the present invention is to provide methods, apparatus and systems technique for implementing a practical memory area search cache on IA-64 and other processors which cannot atomically handle data larger than one word. To achieve this aspect, the present invention is implemented as a data processing method which carries out memory area searches associated with program execution by a computer in a multi-thread environment. The method comprising the steps of: reading an entry corresponding to a given search address from a cache table stored in memory; reading, from memory, a memory area structure indicated by a pointer registered in the entry; and handling the memory area structure as a search result if the search address lies between the start and end addresses stored in the memory area structure.

The present invention is also implemented as a data processing method carried out by a computer in a multi-thread environment, comprising the steps of: reading data at a desired address in memory; running a given process using the read data; and checking whether the data at the address has been overwritten by another thread after execution of the process.

Another data processing method according to the present invention comprises the steps of: reading a pointer written to a desired address in memory; reading, from memory, data pointed to by the pointer which has been read; and checking whether content of the address has been overwritten by another thread after the reading of the data and running a process using the data if the content of the address has not been overwritten.

Still another data processing method according to the present invention comprises the steps of: reading a pointer associated with a given address from memory; reading, from memory, a memory area structure indicated by the pointer which has been read; and checking whether the pointer has been overwritten by another thread between the time when the pointer is read and the time when the memory area structure is read and running a process using the memory area structure if the pointer has not been overwritten.

Another aspect of the present invention is implemented as a memory area search cache, comprising: a memory area structure stored in a given memory area; a cache table in which a pointer to the memory area structure is registered; and a memory area searcher for retrieving the memory area structure with reference to the cache table, wherein the memory area searcher checks whether or not an entry in the cache table has been overwritten after retrieving the memory area structure based on the entry and handles the retrieved memory area structure as a search result if the entry has not been overwritten.

Furthermore, the present invention can be implemented as a program (run-time module) which implements the functions corresponding to the steps of the data processing methods described above, or the memory area search system described above, on a computer. This program can be distributed in a magnetic disk, optical disk, semiconductor memory, or other recording medium, delivered via networks, and provided otherwise.

### DESCRIPTION OF THE DRAWINGS

These and other aspects, features, and advantages of the present invention will become apparent upon further consideration of the following detailed description of the invention when read in conjunction with the drawing figures, in which:

FIG. 1 is a diagram illustrating an example of a configuration of a computer on which a memory area search cache according to an embodiment of the present invention is implemented;

FIG. 2 is a diagram showing a data structure of a memory area search cache according to this embodiment;

FIG. 3 is a diagram showing an example of memory access in a multi-thread environment;

FIG. 4 is a diagram showing an example of a algorithm for implementing the memory area search cache according to this embodiment;

FIG. 5 a flowchart illustrating data processing operations performed during a memory area search, using the memory area search cache according to this embodiment and based on the algorithm shown in FIG. 4;

FIG. 6 a flowchart illustrating data processing operations performed to release a memory area, using the memory area search cache according to this embodiment and based on the algorithm shown in FIG. 4;

FIG. 7 is a flowchart illustrating a typical flow of data processing performed when an advanced load is used across multiple threads;

FIG. 8 is a diagram illustrating data processing in which two words are handled atomically by using an advanced load; and

FIG. 9 is a diagram showing a data structure of a conventional memory area search cache.

### DESCRIPTION OF SYMBOLS

10 . . . CPU (central processing unit)

20 . . . Memory

21 . . . Program

30 . . . Cache table

40 . . . Memory area structure

### DESCRIPTION OF THE INVENTION

The present invention provides methods, apparatus and systems for implementing a practical memory area search cache on, for example, IA-64 and other processors which cannot atomically handle data larger than one word. In an example embodiment a data processing method carries out memory area searches associated with program execution by a computer in a multi-thread environment. The method comprising the steps of: reading an entry corresponding to a given search address from a cache table stored in memory; reading, from memory, a memory area structure indicated by a pointer registered in the entry; and handling the memory area structure as a search result if the search address lies between the start and end addresses stored in the memory area structure.

More preferably, the data processing method further comprises a step of checking after reading the memory area structure whether the entry in the cache table has been overwritten, wherein the step of handling the memory area structure handles the memory area structure as a search result if the entry has not been overwritten.

Also, the function of reading an entry reads the entry at a read instruction which involves detecting a write to the memory; and the function of checking whether the entry has been overwritten checks for any write using a function of the read instruction. As the read instruction, an “advanced load” is used in the case of IA-64 processors.

In another embodiment of the present invention a data processing method is carried out by a computer in a multi-thread environment The method comprises the steps of: reading data at a desired address in memory; running a given process using the read data; and checking whether the data at the address has been overwritten by another thread after execution of the process.

In still another embodiment, a data processing method according to the present invention comprises the steps of: reading a pointer written to a desired address in memory; reading, from memory, data pointed to by the pointer which has been read; and checking whether content of the address has been overwritten by another thread after the reading of the data and running a process using the data if the content of the address has not been overwritten.

Still another embodiment of a data processing method according to the present invention comprises the steps of: reading a pointer associated with a given address from memory; reading, from memory, a memory area structure indicated by the pointer which has been read; and checking whether the pointer has been overwritten by another thread between the time when the pointer is read and the time when the memory area structure is read and running a process using the memory area structure if the pointer has not been overwritten.

More preferably, the data processing method further comprises a step of checking after reading the memory area structure whether the given address lies between the start and end addresses stored in the memory area structure, wherein the step of handling the memory area structure handles the memory area structure as a search result if the given address lies between the start and end addresses stored in the memory area structure.

Also the function of reading a pointer reads the pointer at a read instruction which involves detecting a write to the memory; and the function of checking whether the pointer has been overwritten checks for any write using a function of the read instruction. As the read instruction, an “advanced load” is used in the case of IA-64 processors.

The present invention is also implemented as a memory area search cache, comprising: a memory area structure stored in a given memory area; a cache table in which a pointer to the memory area structure is registered; and a memory area searcher for retrieving the memory area structure with reference to the cache table, wherein the memory area searcher checks whether or not an entry in the cache table has been overwritten after retrieving the memory area structure based on the entry and handles the retrieved memory area structure as a search result if the entry has not been overwritten.

In more particularl embodiments, the cache table here has entries one word in size and the pointer to the memory area structure is registered in one of the entries. Also, the memory area searcher here searches for the memory area structure using binary search instead of using the cache table if it detects that the entry has been overwritten.

Furthermore, the present invention can be implemented as a program (run-time module) which implements the functions corresponding to the steps of the data processing methods described above, or the memory area search system described above, on a computer. This program can be distributed in a magnetic disk, optical disk, semiconductor memory, or other recording medium, delivered via networks, and provided otherwise.

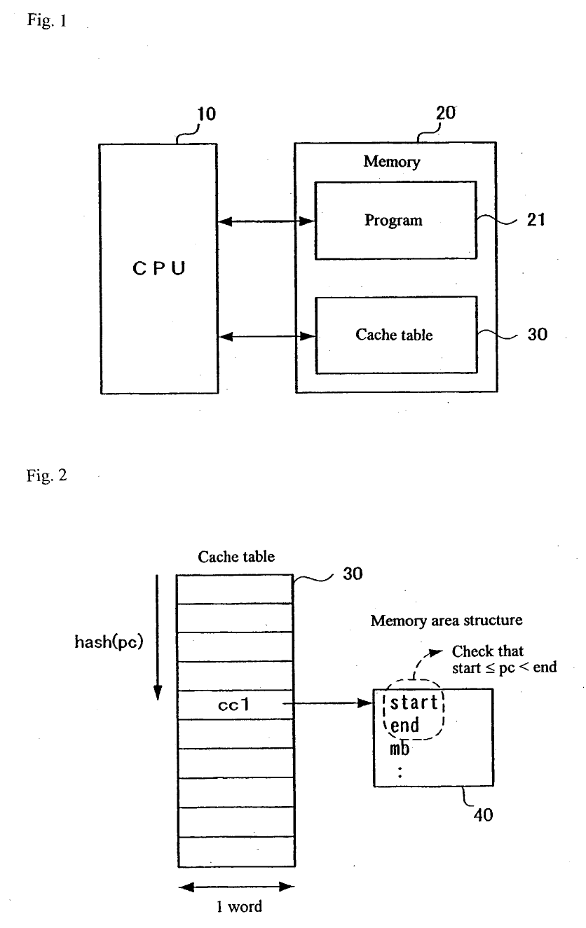

The present invention will be further described with reference to an embodiment shown in the accompanying drawings. FIG. 1 is a diagram illustrating a configuration of a computer on which a memory area search cache according to this embodiment is implemented. Referring to FIG. 1, the memory area search cache according to the present invention comprises a CPU (Central Processing Unit) 10 as a means of running programs or as a data processing means for processing data by running the programs, and a memory 20 which stores programs for controlling the CPU 10 and stores various data. Incidentally, FIG. 1 shows only components characteristic to this embodiment. Actually, it goes without saying that various peripheral devices are connected to the CPU 10 via a bridge circuit (chipset) and various buses. Besides, it is also possible to make multiple CPUs share a single memory.

As shown in FIG. 1, the memory 20 stores a program 21 which performs data processing by controlling the CPU 10, and a cache table 30 used for the memory area search cache provided by this embodiment. The program 21 includes a run-time module which performs data processing for implementing the memory area search cache according to this embodiment. Also, the memory 20 stores, in a given memory area, a memory area structure (not shown) generated when the program 21 is executed. Incidentally, the memory 20 shown in FIG. 1 does not necessarily represents a single storage unit. Specifically, although the memory 20 indicates a main memory implemented chiefly by a RAM, the program 21 can be saved, as required, in an external storage unit such as a magnetic disk.

FIG. 2 is a diagram showing a data structure of the memory area search cache according to this embodiment. As shown in FIG. 2, the data structure of the memory area search cache according to this embodiment consists of a cache table 30 which has entries one word in size and a memory area structure 40 which is pointed to by (which corresponds to) a search address. Each cache entry contains information one word in size:

{pointer to memory area structure}

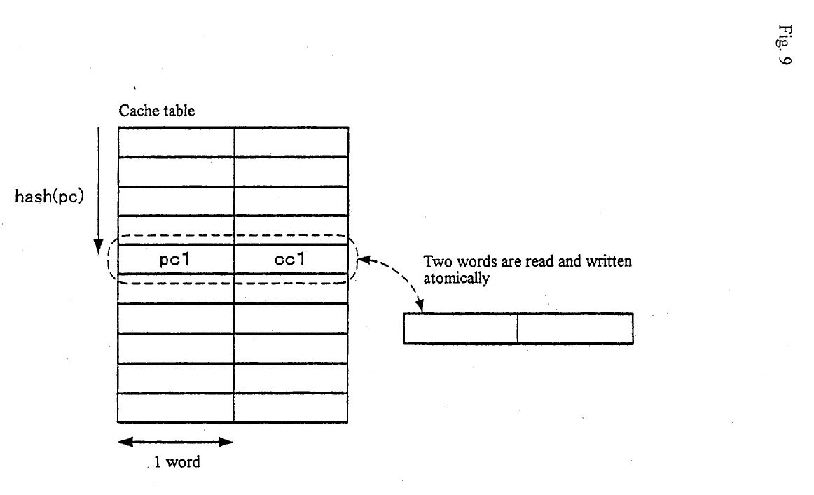

In this case, since a search address which corresponds to the “pointer to a memory area structure” is not cached together unlike a conventional cache table (see FIG. 9), it is necessary to judge with reference to the cache table 30 whether the memory area structure 40 which has been read really corresponds to a given search address.

Since memory areas never overlap, the judgment can be made by checking that:

Start address of memory area≦Search address<End address of memory area

In a multi-thread environment, however, since the memory area and memory area structure 40 may be released and reused by another thread, correspondence between a cache entry and memory area may be changed between the time when the cache entry is read and the time when the start and end addresses stored in the corresponding memory area structure 40 are read. In that case, the correct memory area cannot be searched for because the content of the memory area read according to the cache entry has been changed.

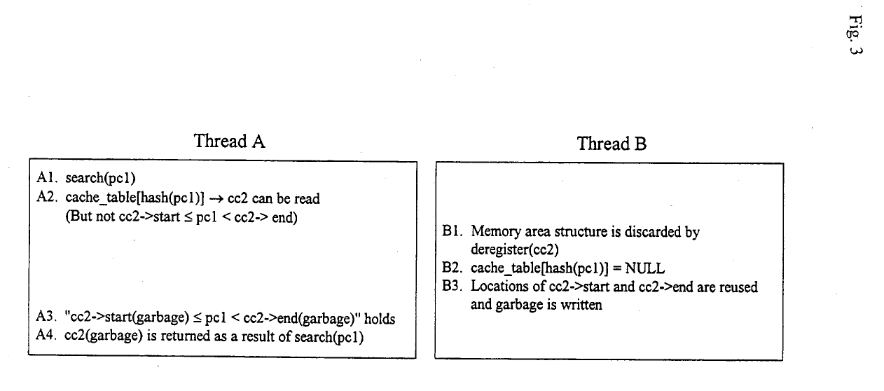

FIG. 3 is a diagram showing an example of memory access which can bring about such a situation in a multi-thread environment. Referring to FIG. 3, when thread A starts searching for address pc1 (A1), it reads the pointer to cc2—the memory area structure 40—registered in the entry which corresponds to pc1 in the cache table 30 (A2). It is assumed here that address pc1 does not lie between the start and end addresses of cc2. In other words, the cc2 represent another memory area. In this case, since a search using cache will normally fail, a time-consuming process such as a binary search must be carried out.

After thread A reads the cache entry, thread B discards cc2, the memory area structure 40 (B1), sets the entry which corresponds to pc1 in the cache table 30 to NULL (B2), and writes other data (garbage) into cc2 (B3). When thread A reads cc2 later (A3), if address pc1 happens to lie between the start and end addresses of the data (garbage) written by thread B, it retrieves the wrong data (garbage: rather than the memory area structure 40 which corresponds to address pc1) from cc2 as a search result of address pc1 (A4).

To avoid such situations, according to this embodiment, after thread A reads cc2, it is checked whether the content of the cache entry at pc1 has been overwritten. In the example of FIG. 3, since the cache entry has been overwritten by thread B in B2, the search using the cache will fail.

As a simple technique for checking whether the cache entry for pc1 has been overwritten, thread A can compare the cache entry read before and after cc2 is read. However, this technique cannot recognize overwrites in the following case. Specifically, if cc2 is used again as a memory area structure 40 by another thread and consequently the pointer to the memory area structure 40 is written by chance into the cache entry at pc1 after cc2 is read but before the cache entry is read, the contents read from the cache entry the first and second times coincide, and thus the above technique cannot recognize that the cache entry has been overwritten.

Thus as a technique for checking whether the cache entry at pc1 has been overwritten, this embodiment adopts a mechanism called “advanced load” which is provided in IA-64 processors. The “advanced load” is a mechanism provided in IA-64 processors to implement data speculation (speculative execution). The data speculation is a technique for hiding memory latency by moving a load ahead of a store in compiling a program. If there is a possibility that data loading depends on a store, it is not possible to simply execute a load prior to a store. Thus, by means of data speculation, a check instruction is included in code to check for dependency, and recovery is performed if data dependency is found. The “advanced load” is a mechanism for implementing this feature by checking whether a write has been done to a given address.

Thus, the “advanced load,” originally intended to implement data speculation, is a feature for checking for any write to memory within a thread. However, in the method for implementing the memory area search cache according to this embodiment, this feature is used expansively across multiple threads to detect data changes made by other threads.

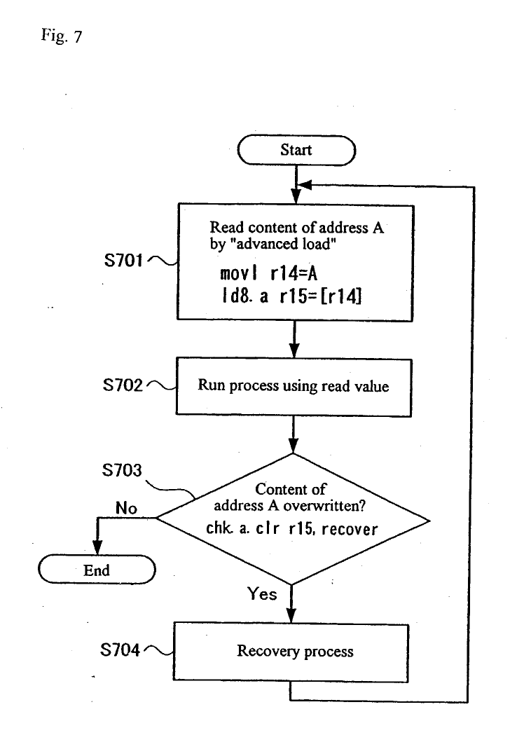

FIG. 7 is a flowchart illustrating a typical flow of data processing performed when an advanced load is used across multiple threads. Referring to FIG. 7, to use data written into address A in a given thread, the CPU 10 loads the content of address A into a register (denoted as r15 tentatively) ahead of time (Step 701). Then, the CPU 10 runs a process desired by the thread using the value read into the register r15 (Step 702). During the process of Step 702, the CPU 10 checks whether the data at address A has been changed by another thread. If the data has not been changed, the CPU 10 finishes the processing (Step 703). If the data at address A has been changed, the CPU 10 performs a necessary recovery process (Step 704) and starts from the beginning again.

This example embodiment allows IA-64 processors which normally cannot read and write data larger than one word (64 bits) atomically to handle multiple words atomically by using the data processing shown in FIG. 7 instead of heavy processing such as exclusive control by means of locking.

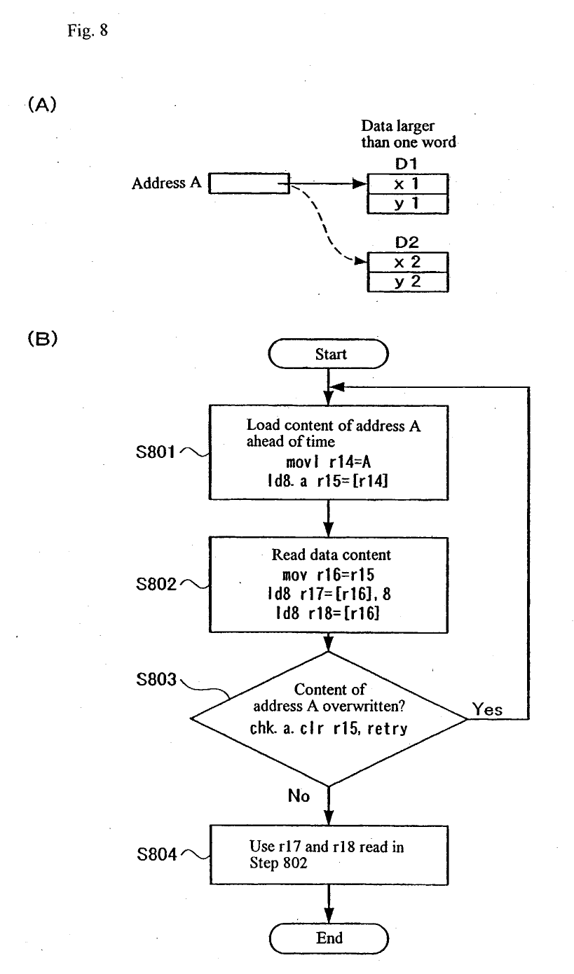

FIG. 8 is a diagram illustrating data processing in which two words are handled atomically by using an advanced load. In this case, as shown in FIG. 8A, data larger than one word is held in data D1 (x1, y1) pointed to by a pointer stored at address A. When the data is updated, new data structure D2 is provided and registered at address A with its contents x2 and y2 specified. Incidentally, data D1 will never have its contents changed as long as it is pointed to by address A. Conversely, data D1 may be overwritten if it is not pointed to by address A.

Referring to a flowchart in FIG. 8B which illustrates a data processing flow, to use data pointed to by address A in a given thread, the CPU 10 loads the content (pointer) of address A into a register (denoted as r15 tentatively) ahead of time (Step 801). Then the CPU 10 reads the data pointed to by the pointer loaded into r15 (Step 802). This is two words of separate data (D1: x1, y1). It is assumed here that the data which have been read are stored in registers r16 and r17, respectively.

Then, the CPU 10 checks that the contents of address A have not been overwritten, meaning that data D1 did not stop to be pointed to by the pointer at address A while data x1 and y1 were read in Step 802 (Step 803). If it is confirmed that the contents of address A have not been overwritten, this assures that the contents x1 and y1 of r16 and r17 read in Step 802 are consistent, and thus the CPU 10 performs processing using these data (Step 804). On the other hand, if it is confirmed in Step 803 that the contents of address A have been overwritten, the CPU 10 returns to Step 801 and starts from the beginning.

According to this embodiment, the technique for detecting data changes across multiple threads by means of advanced loads and technique for atomically handling data larger than one word on an IA-64 processor are used for the purpose of retrieving a memory area structure 40 with reference to the cache table 30 shown in FIG. 2.

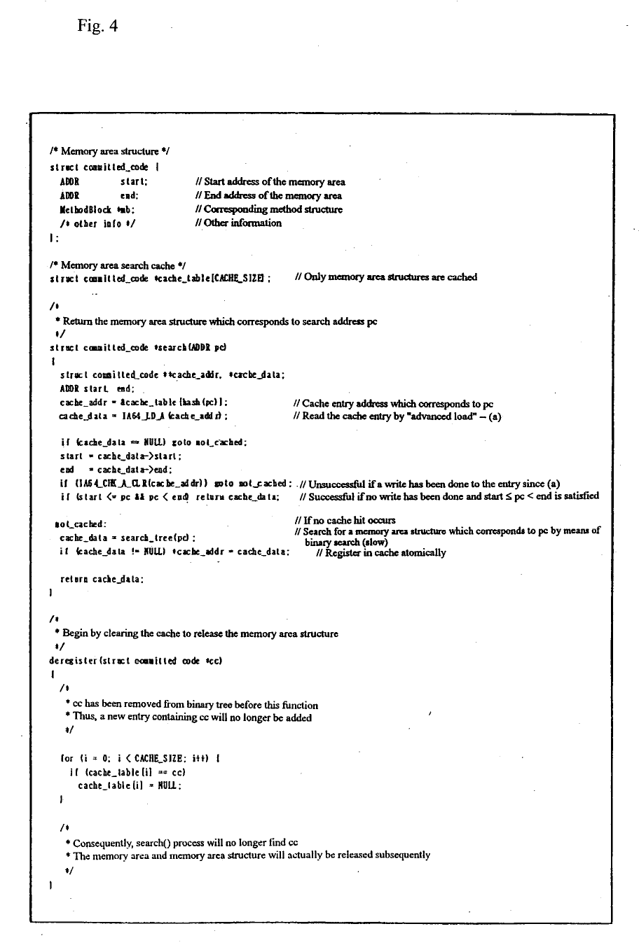

FIG. 4 is a diagram showing an algorithm for implementing the memory area search cache according to this embodiment. Referring to FIG. 4, on the line

“cache_data=IA64_LD_A(cache_addr);”

printed in bold type, a cache entry is advance-loaded. Also, on the line

“if (IA64_CHK_A_CLR(cache_addr)) goto not_cached;”, it is checked whether a write has been done to the cache entry.

According to this embodiment, operations of the algorithm shown in FIG. 4 are performed by a run-time module invoked, as required, during execution of the program 21. If this run-time module is called during execution of the program, the CPU 10 operates as a memory area search means under the control of the run-time module.

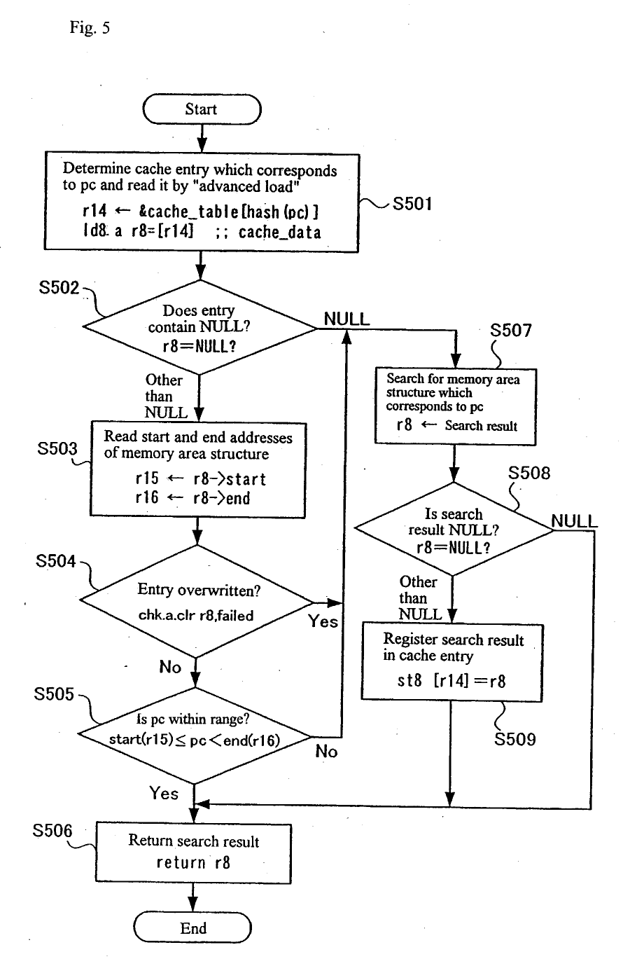

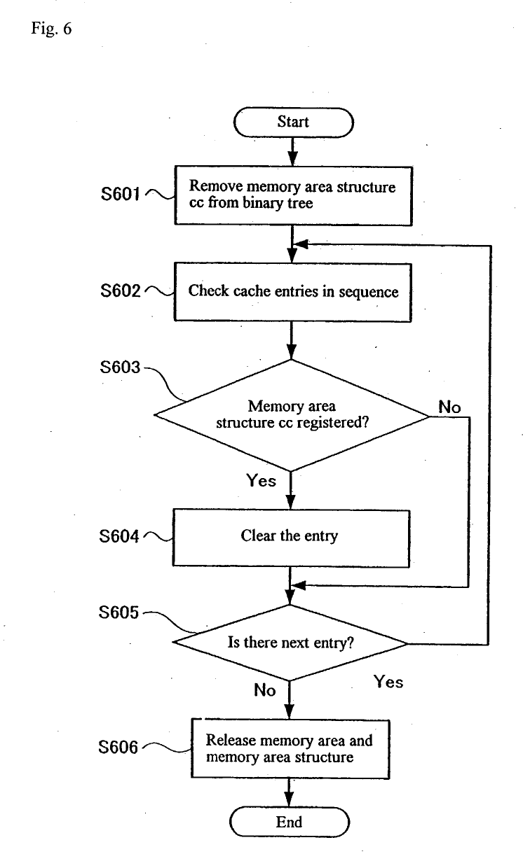

FIGS. 5 and 6 are flowcharts illustrating data processing operations performed using the memory area search cache according to this embodiment and based on the algorithm shown in FIG. 4. FIG. 5 shows operations during a memory area search while FIG. 6 shows operations for releasing a memory area. As shown in FIG. 5, when the run-time module is called at the request of a given process in order to search for a memory area, then in accordance with this run-time module, the CPU 10 determines the cache entry which corresponds to a search address pc received from the calling module and read it by “advanced load” (Step 501). Then, the CPU 10 checks whether the content of the cache entry is “NULL.” If the cache entry contains a value other than “NULL,” i.e., if a pointer to a memory area structure 40 has been registered, the CPU 10 loads the memory area structure 40 pointed to by the pointer and reads out its start and end addresses (Steps 502 and 503). Subsequently, the CPU 10 checks whether the content of the cache entry has been overwritten (Step 504). If it has not been overwritten, the CPU 10 further checks whether address pc lies in the range between the start and end addresses stored in the memory area structure 40 (Steps 504 and 505). If it lies in the range, the CPU 10 returns the memory area structure 40 as a search result to the caller of the run-time module (Step 506).

On the other hand, if it turns out in Step 502 that the cache entry contains “NULL,” if it turns out in Step 504 that the content of the cache entry has been overwritten, or if it turns out in Step 505 that address pc lies outside the range between the start and end addresses stored in the memory area structure 40, the cache fails to retrieve the memory area structure 40. Consequently, the CPU 10 searches for the memory area structure 40 which corresponds to address pc by means of binary search (Step 507). Then, the CPU 10 judges whether the search result is “NULL.” If it is not “NULL,” the CPU 10 registers the pointer to the memory area structure 40, which is the result of the binary search, in the cache entry at address pc (Steps 508 and 509) and returns the search result to the caller of the run-time module (Step 506). On the other hand, if the search result is “NULL,” the CPU 10 returns this value as a search result (Steps 508 and 506).

Operations performed to release a memory area will be described next. Referring to FIG. 6, the CPU 10 removes the given memory area structure 40 from the binary tree used for binary search, under the control of the run-time module which is releasing the memory area (Step 601). Then, the CPU 10 checks the entries of the cache table 30 in sequence to see whether the memory area structure 40 has been registered, and clears the cache entry in which the memory area structure 40 has been registered (Steps 602 to 605). Then, the CPU 10 releases the memory area and the memory area structure 40 (Step 606).

Thus, as described above, the present invention makes it possible to implement a practical memory area search cache on IA-64 and other processors which cannot atomically handle data larger than one word.

Variations described for the present invention can be realized in any combination desirable for each particular application. Thus particular limitations, and/or embodiment enhancements described herein, which may have particular advantages to the particular application need not be used for all applications. Also, not all limitations need be implemented in methods, systems and/or apparatus including one or more concepts of the present invention.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

What is claimed is:

1. A data processing method comprises carrying out at least one memory area search associated with program execution by a computer in a multi-thread environment, comprising the steps of:
reading an entry corresponding to a given search address from a cache table stored in memory;
reading, from memory, a memory area structure indicated by a pointer registered in said entry; and
handling said memory area structure as a search result if said search address lies between start and end addresses stored in said memory area structure.

2. The data processing method according to claim 1, further comprising a step of checking after reading said memory area structure whether said entry in said cache table has been overwritten,
wherein said step of handling said memory area structure handles said memory area structure as a search result if said entry has not been overwritten.

3. A data processing method comprising:
carrying out by a computer in a multi-thread environment the steps of:
reading data at a desired address in memory;
running a given process using said read data; and
checking whether the data at said address has been overwritten by another thread after execution of said process.

4. A data processing method comprising:
carrying out by a computer in a multi-thread environment the steps of:
reading a pointer written to a desired address in memory;
reading, from memory, data pointed to by said pointer which has been read; and
checking whether content of said address has been overwritten by another thread after the reading of said data and running a process using said data if the content of said address has not been overwritten.

5. A data processing method comprising:
carrying out by a computer in a multi-thread environment the steps of:
reading a pointer associated with a given address from memory;
reading, from memory, a memory area structure indicated by said pointer which has been read; and
checking whether said pointer has been overwritten by another thread between the time when said pointer is read and the time when said memory area structure is read and running a process using said memory area structure if said pointer has not been overwritten.

6. The data processing method according to claim 5, further comprising a step of checking after reading said memory area structure whether said given address lies between the start and end addresses stored in the memory area structure,
wherein said step of handling said memory area structure handles said memory area structure as a search result if said given address lies between the start and end addresses stored in said memory area structure.

7. A memory area search system on a computer, comprising:
a memory area structure stored in a given memory area;
a cache table in which a pointer to said memory area structure is registered; and
a memory area searcher for retrieving said memory area structure with reference to said cache table,
wherein said memory area searcher checks whether or not an entry in said cache table has been overwritten after retrieving said memory area structure based on said entry and handles said retrieved memory area structure as a search result if said entry has not been overwritten.

8. The memory area search system according to claim 7, wherein said cache table has entries one word in size and the pointer to said memory area structure is registered in one of the entries.

9. The memory area search system according to claim 7, wherein said memory area searcher searches for said memory area structure using binary search if said entry has been overwritten.

10. An article of manufacture comprising a computer usable medium having computer readable program code means embodied therein for causing the carrying out of at least one memory area search associated with program execution, the computer readable program code means in said article of manufacture comprising computer readable program code means for causing a computer to effect the steps of claim 1.

11. The program according to claim 10, further making the computer implement a function of checking after reading said memory area structure whether said entry in said cache table has been overwritten,
wherein said function of handling said memory area structure handles said memory area structure as a search result if said entry has not been overwritten.

12. The program according to claim 11, wherein:
said function of reading an entry reads said entry at a read instruction which involves detecting a write to said memory; and
said function of checking whether said entry has been overwritten checks for any write using a function of said read instruction.

13. An article of manufacture comprising a computer usable medium having computer readable program code means embodied therein for causing the carrying out data processing in a multi-thread environment by controlling a computer, the computer readable program code means in said article of manufacture comprising computer readable program code means for causing a computer to effect the steps of claim 4.

14. The program according to claim 13, further making the computer implement a function of checking after reading said memory area structure whether said given address lies between the start and end addresses stored in the memory area structure,
wherein said function of handling said memory area structure handles said memory area structure as a search result if said given address lies between the start and end addresses stored in said memory area structure.

15. The program according to claim 13, wherein:
said function of reading an entry reads said entry at a read instruction which involves detecting a write to said memory; and
said function of checking whether said pointer has been overwritten checks for any write using a function of said read instruction.

16. A program storage device readable by machine, tangibly embodying a program of instructions executable by the machine to perform method steps for carrying out memory area searches associated with program execution by a computer in a multi-thread environment, said method steps comprising the steps of claim 1.

17. A program storage device readable by machine, tangibly embodying a program of instructions executable by the machine to perform method steps for carrying out memory area searches associated with program execution by a computer in a multi-thread environment, said method steps comprising the steps of claim 4.

18. An article of manufacture comprising a computer usable medium having computer readable program code means embodied therein for causing data processing, the computer readable program code means in said article of manufacture comprising computer readable program code means for causing a computer to effect the steps of claim 3.

19. A program storage device readable by machine, tangibly embodying a program of instructions executable by the machine to perform method steps for data processing, said method steps comprising the steps of claim 3.

20. A computer program product comprising a computer usable medium having computer readable program code means embodied therein for causing a memory area search system, the computer readable program code means in said computer program product comprising computer readable program code means for causing a computer to effect the functions of claim 7.
